(19) United States
(12) Patent Application Publication
(10) Pub. No.: US 2022/0129731 A1
(43) Pub. Date: Apr. 28, 2022

(54) METHOD AND APPARATUS FOR TRAINING IMAGE RECOGNITION MODEL, AND METHOD AND APPARATUS FOR RECOGNIZING IMAGE

(71) Applicant: Beijing Baidu Netcom Science Technology Co., Ltd., Beijing (CN)

(72) Inventors: Ruoyu GUO, Beijing (CN); Yuning DU, Beijing (CN); Chenxia LI, Beijing (CN); Tingquan GAO, Beijing (CN); Qiao ZHAO, Beijing (CN); Qiwen LIU, Beijing (CN); Ran BI, Beijing (CN); Xiaoguang Hu, Beijing (CN); Dianhai YU, Beijing (CN); Yanjun MA, Beijing (CN)

(21) Appl. No.: 17/568,296

(22) Filed: Jan. 4, 2022

(30) Foreign Application Priority Data
May 27, 2021 (CN) 202110586872.0

(51) Int. Cl. G06N 3/04; G06N 3/08

(52) U.S. Cl. CPC G06N 3/0427; G06N 3/08

(57) ABSTRACT

The present disclosure provides a method and apparatus for training an image recognition model, and a method and apparatus for recognizing an image, and relates to the field of artificial intelligence, and particularly to the fields of deep learning and computer vision. A specific implementation comprises: acquiring a tagged sample set, an untagged sample set and a knowledge distillation network; and performing following training steps: selecting an input sample from the tagged sample set and the untagged sample set, and accumulating a number of iterations; inputting respectively the input sample into a student network and a teacher network of the knowledge distillation network to train the student network and the teacher network; and selecting an image recognition model from the student network and the teacher network, if a training completion condition is satisfied.

### CROSS-REFERENCE TO RELATED APPLICATIONS

This application claims priority to Chinese Patent Application No. 202110586872.0, filed with the China National Intellectual Property Administration (CNIPA) on May 27, 2021, the contents of which are incorporated herein by reference in their entirety.

### TECHNICAL FIELD

The present disclosure relates to the field of artificial intelligence, particularly to the fields of deep learning and computer vision, and specifically to a method and apparatus for training an image recognition model, and a method and apparatus for recognizing an image.

### BACKGROUND

In the field of image classification, there are many mature methods in a knowledge distillation method, which are basically to allow a student network to learn a soft tag output or feature map of a teacher network. However, in an OCR (Optical Character Recognition) recognition task, knowledge distillation is currently few applied. For a CRNN (Convolutional Recurrent Neural Network) model, the effect of directly distilling a soft tag of the student network is not as high as the precision obtained by directly performing training based on annotated information. In addition, during the distilling, there is a need for a higher precision teacher network to instruct the training for the student network. However, features for supervision are still limited in expressiveness because of a small network.

### SUMMARY

The present disclosure provides a method and apparatus for training an image recognition model, a method and apparatus for recognizing an image, a device, a storage medium and a computer program product.

In a first aspect, an embodiment of the present disclosure provides a method for training an image recognition model, and the method comprises: acquiring a tagged sample set, an untagged sample set and a knowledge distillation network, wherein a sample in the tagged sample set comprises a sample image and a real tag, and a sample in the untagged sample set comprises a sample image and a uniform identifier; and performing following training steps: selecting an input sample from the tagged sample set and the untagged sample set, and accumulating a number of iterations; inputting respectively the input sample into a student network and a teacher network of the knowledge distillation network to train the student network and the teacher network; and selecting an image recognition model from the student network and the teacher network, if a training completion condition is satisfied.

In a second aspect, an embodiment of the present disclosure provides a method for recognizing an image, the method comprises: acquiring a to-be-recognized image; and inputting the image into an image recognition model generated using the method according to the first aspect, to generate a recognition result.

In a third aspect, an embodiment of the present disclosure provides an apparatus for training an image recognition model, and the apparatus comprises: an acquiring unit, configured to acquire a tagged sample set, an untagged sample set and a knowledge distillation network, wherein a sample in the tagged sample set comprises a sample image and a real tag, and a sample in the untagged sample set comprises a sample image and a uniform identifier; and a training unit, configured to perform following training steps: selecting an input sample from the tagged sample set and the untagged sample set, and accumulating a number of iterations; inputting respectively the input sample into a student network and a teacher network of the knowledge distillation network to train the student network and the teacher network; and selecting an image recognition model from the student network and the teacher network, if a training completion condition is satisfied.

In a fourth aspect, an embodiment of the present disclosure provides an apparatus for recognizing an image, comprising: an acquiring unit, configured to acquire a to-be-recognized image; and a recognizing unit, configured to input the image into an image recognition model generated using the apparatus according to the third aspect, to generate a recognition result.

In a fifth aspect, an embodiment of the present disclosure provides a computer program product, the computer program product comprises: at least one processor; and a storage device, communicated with the at least one processor, wherein the storage device stores an instruction executable by the at least one processor, and the instruction is executed by the at least one processor, to enable the at least one processor to perform the method according to the first aspect or the second aspect.

In a sixth aspect, an embodiment of the present disclosure provides a non-transitory computer readable storage medium, the medium stores a computer instruction, wherein the computer instruction is used to cause a computer to perform the method according to the first aspect or the second aspect.

In a seventh aspect, an embodiment of the present disclosure provides a computer program product, the computer program product comprises a computer program, wherein the computer program, when executed by a processor, implements the method according to the first aspect or the second aspect.

According to the method and apparatus for training an image recognition model provided in the embodiments of the present disclosure, the knowledge distillation method can be effectively applied to the CRNN-based OCR recognition task. Accordingly, in a situation where the precision of a small model is improved, the amount of calculation of the model at the time of prediction is kept completely unchanged, thereby improving the practicality of the model. Semantic information of the untagged data is fully utilized, which further improves the precision and generalization performance of the recognition model. Accordingly, the method may be well extended to other visual tasks.

It should be understood that the content described in this part is not intended to identify key or important features of the embodiments of the present disclosure, and is not used to limit the scope of the present disclosure. Other features of the present disclosure will be easily understood through the following description.

### BRIEF DESCRIPTION OF THE DRAWINGS

The accompanying drawings are used for a better understanding of the scheme, and do not constitute a limitation to the present disclosure. Here:

FIG. 1 is a diagram of an exemplary system architecture in which the present disclosure may be applied;

FIG. 2 is a flowchart of an embodiment of a method for training an image recognition model according to the present disclosure;

FIG. 3 is a schematic diagram of an application scenario of the method for training an image recognition model according to the present disclosure;

FIG. 4 is a flowchart of an embodiment of a method for recognizing an image according to the present disclosure;

FIG. 5 is a schematic structure diagram of an embodiment of an apparatus for training an image recognition model according to the present disclosure;

FIG. 6 is a schematic structure diagram of an embodiment of an apparatus for recognizing an image according to the present disclosure; and

FIG. 7 is a schematic structure diagram of a computer system of an electronic device adapted to implement embodiments of the present disclosure.

### DETAILED DESCRIPTION OF EMBODIMENTS

Exemplary embodiments of the present disclosure are described below in combination with the accompanying drawings, and various details of the embodiments of the present disclosure are included in the description to facilitate understanding, and should be considered as exemplary only. Accordingly, it should be recognized by one of ordinary skill in the art that various changes and modifications may be made to the embodiments described herein without departing from the scope and spirit of the present disclosure. Also, for clarity and conciseness, descriptions for well-known functions and structures are omitted in the following description.

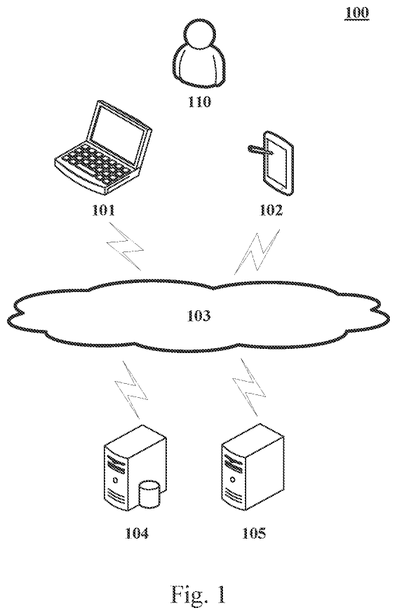

FIG. 1 illustrates an exemplary system architecture 100 in which a method for training an image recognition model, an apparatus for training an image recognition model, a method for recognizing an image or an apparatus for recognizing an image according to an embodiment of the present disclosure may be applied.

As shown in FIG. 1, the system architecture 100 may include terminals 101 and 102, a network 103, a database server 104 and a server 105. The network 103 serves as a medium providing a communication link between the terminals 101 and 102, the database server 104 and the server 105. The network 103 may include various types of connections, for example, wired or wireless communication links, or optical fiber cables.

A user 110 may use the terminals 101 and 102 to interact with the server 105 via the network 103, to receive or send a message, etc. Various client applications (e.g., a model training application, an image recognition application, a shopping application, a payment application, a webpage browser and an instant communication tool) may be installed on the terminals 101 and 102.

The terminals 101 and 102 here may be hardware or software. When being the hardware, the terminals 101 and 102 may be various electronic devices having a display screen, the electronic devices including, but not limited to, a smartphone, a tablet computer, an e-book reader, an MP3 player (Moving Picture Experts Group Audio Layer III), a laptop portable computer, a desktop computer, and the like. When being the software, the terminals 101 and 102 may be installed in the above listed electronic devices. The terminals 101 and 102 may be implemented as a plurality of pieces of software or a plurality of software modules (e.g., software or software modules for providing a distributed service), or may be implemented as a single piece of software or a single software module, which will not be specifically limited here.

When the terminals 101 and 102 are the hardware, an image collection device may further be installed in the terminals 101 and 102. The image collection device may be various devices capable of realizing an image collection function, for example, a camera and a sensor. The user 110 may use the image collection device on the terminals 101 and 102 to collect various images containing a text, for example, a ticket image, a street view image, a certification card image. These data contains a large amount of semantic information although the data is not annotated with information.

The database server 104 may be a database server providing various services. For example, the database server may store a sample set. The sample set contains a large number of samples. Here, the samples may include a sample image and a real tag corresponding to the sample image. In this way, the user 110 may alternatively select, from the sample set stored in the database server 104, a sample through the terminals 101 and 102.

The server 105 may also be a server providing various services, for example, a backend server providing support for various applications displayed on the terminals 101 and 102. The backend server may train a knowledge distillation network by using a sample in the sample set sent by the terminals 101 and 102, and may send a training result (e.g., a generated image recognition model) to the terminals 101 and 102. In this way, the user may apply the generated image recognition model to perform image recognition, for example, to recognize a text in an invoice.

Here, the database server 104 and the server 105 may also be hardware or software. When being the hardware, the database server 104 and the server 105 may be implemented as a distributed server cluster composed of a plurality of servers, or may be implemented as a single server. When being the software, the database server 104 and the server 105 may be implemented as a plurality of pieces of software or a plurality of software modules (e.g., software or software modules for providing a distributed service), or may be implemented as a single piece of software or a single software module, which will not be specifically limited here.

It should be noted that the method for training an image recognition model or the method for recognizing an image provided in the embodiments of the present disclosure is generally performed by the server 105. Correspondingly, the apparatus for training an image recognition model or the apparatus for recognizing an image is generally provided in the server 105.

It should be pointed out that, in the situation where the server 105 may implement the relevant functions of the database server 104, the database server 104 may not be provided in the system architecture 100.

It should be appreciated that the numbers of the terminals, the networks, the database servers and the servers in FIG. 1 are merely illustrative. Any number of terminals, networks, database servers and servers may be provided based on actual requirements.

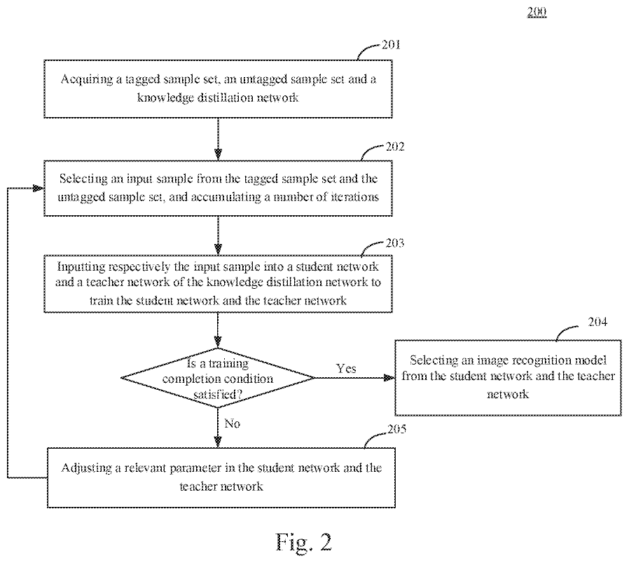

Further referring to FIG. 2, FIG. 2 illustrates a flow 200 of an embodiment of a method for training an image recognition model according to the present disclosure. The method for training an image recognition model may include the following steps:

Step 201, acquiring a tagged sample set, an untagged sample set and a knowledge distillation network.

In this embodiment, an executing body (e.g., the server 105 shown in FIG. 1) of the method for training an image recognition model may acquire a sample set by various means. As an example, the executing body may acquire, from a database server (e.g., the database server 104 shown in FIG. 1), an existing sample set stored in the database server, by means of a wired connection or by means of a wireless connection. As another example, a user may collect samples through a terminal (e.g., the terminals 101 and 102 shown in FIG. 1). In this way, the executing body may receive the samples collected by the terminal and store the samples locally, thereby generating a sample set.

The sample set is divided into two types: a tagged sample set and an untagged sample set. Here, the sample in the tagged sample set includes a sample image and a real tag, and the sample in the untagged sample set includes a sample image and a uniform identifier. A tagged sample is a manually annotated sample. For example, an image includes a signboard of “XX Hospital,” the annotated real tag refers to XX Hospital. An untagged sample is an image that is not annotated, and may be set to a uniform identifier, for example, a character string like ##### that is unlikely to appear in a real tag.

The knowledge distillation network includes a student network and a teacher network. Both the student network and the teacher network are CRNN-based OCR recognition models. Generally, the teacher network is more complex in structure than the student network, but have superior performance. However, the teacher network and the student network in the present disclosure may alternatively adopt the same structure, to improve the performance.

The difference between an OCR task and a classification task or a detection task lies in that one CTC decoding operation is further performed on an outputted soft tag result. Therefore, if a CRNN-based OCR recognition model is directly distilled, the effect is generally poor since it is difficult to ensure that the soft tag decoding result is aligned.

Step 202, selecting an input sample from the tagged sample set and the untagged sample set, and accumulating a number of iterations.

In this embodiment, the executing body may select, from the tagged sample set and the untagged sample set that are acquired in step 201, a sample as an input sample used to be inputted into the knowledge distillation network, and perform the training steps in steps 203-205. Here, the way in which the input sample is selected and the number of selected input samples are not limited in the present disclosure. For example, it is possible that at least one training sample is randomly selected from the tagged sample set and the untagged sample set, respectively, or it is possible that a sample of which the image definition is good (i.e., the pixel is high) is selected from the tagged sample set and the untagged sample set. Alternatively, a fixed number of samples are selected during each iteration, and a number of tagged samples selected each time is greater than a number of untagged samples. Moreover, with the increase of the number of the iterations, the proportion of the tagged samples is increased until the samples used for the last time are all the tagged samples (i.e., no untagged sample is used), and thus, the accuracy of the training may be improved.

The number of the iterations is increased by 1, after each selection for a sample. The number of the iterations may be used to not only control the termination of the training for the model, but also control the proportion of the selected tagged samples.

Step 203, inputting respectively the input sample into a student network and a teacher network of the knowledge distillation network to train the student network and the teacher network.

In this embodiment, the executing body may input a sample image of the input sample selected in step 202 into the student network of the knowledge distillation network, for supervised training. Through the recognition of the student network for the sample image, a recognition result (i.e., a first predicted tag) is obtained. Since a batch of samples are inputted, a first predicted tag set is obtained. The “first predicted tag” and the “second predicted tag” in the present disclosure are only to distinguish the recognition results of the student network and the teacher network, rather than represent an execution order. In fact, it is possible to input the same sample image into the student network and the teacher network at the same time.

In this embodiment, the executing body may input the sample image of the input sample selected in step 202 into the teacher network of the knowledge distillation network. Through the recognition of the teacher network for the sample image, a recognition result (i.e., a second predicted tag) is obtained. Since a batch of samples are inputted, a second predicted tag set is obtained.

In this embodiment, a loss value of the student network may be calculated based on the first predicted tag set and a real tag set, and a loss value of the teacher network may be calculated based on the second predicted tag set and the real tag set. A weighted sum of the loss value of the student network and the loss value of the teacher network is used as a total loss value. Here, during supervised training, the loss value of the student network that is calculated by using the method in which a loss value is calculated based on a real tag set and a predicted tag set is a first hard loss value. Since the number of samples inputted each time is not unique, the first hard loss value of this batch of samples is accumulated. During the supervised training, the loss value of the teacher network that is calculated by using the method in which the loss value is calculated based on the real tag set and the predicted tag set is a second hard loss value. Since the number of the samples inputted each time is not unique, the second hard loss value of this batch of samples is accumulated.

Alternatively, calculating the total loss value based on the first predicted tag set, the second predicted tag set and the real tag set includes: calculating a soft loss value based on the first predicted tag set and the second predicted tag set. The total loss value is calculated based on the soft loss value, the first hard loss value and the second hard loss value. In this embodiment, for the same sample image, the recognition results obtained through two different networks may be different. For example, for an image containing a word “inspire,” the probability that the prediction result of the student network is “inspire” may be 90%, and the probability that the prediction result of the student network is “inquire” may be 10%. For the image containing the word “inspire,” the probability that the prediction result of the teacher network is “inspire” may be 20%, and the probability that the prediction result of the teacher network is “inquire” may be 80%. The soft loss value may be calculated based on the difference between the prediction results of the two networks. Since the number of the samples inputted each time is not unique, the accumulated soft loss value of this batch of samples may be calculated together. The weighted sum of the soft loss value, the first hard loss value and the second hard loss value may be used as the total loss value. The specific weight may be set according to requirements.

Step 204, selecting an image recognition model from the student network and the teacher network, if a training completion condition is satisfied.

In this embodiment, the training completion condition may include: the number of the iterations reaching a maximum number of iterations or the total loss value being less than a predetermined threshold. If the number of the iterations reaches the maximum number of the iterations or the total loss value is less than the predetermined threshold, it indicates that the training for the model is completed, and at this point, one of the student network and the teacher network is selected as the image recognition model. If the network structures of the student network and the teacher network are different, the student network may be used as an image recognition model at a terminal side (e.g., a device of which the processing capability is not very strong, for example, a mobile phone or a tablet), and the teacher network having a complex network structure and having a high requirement on hardware may be used as an image recognition model at a server side.

Step 205, adjusting, if the training completion condition is not satisfied, a relevant parameter in the student network and the teacher network, to continue to perform steps 202-205.

In this embodiment, if the number of the iterations does not reach the maximum number of the iterations and the total loss value is not less than the predetermined threshold, it indicates that the training for the model is not completed, and at this point, the relevant parameter in the student network and the teacher network is adjusted through a back propagation mechanism of a neural network. Then, steps 202-205 are repeatedly performed until the training for the model is completed.

According to the method provided in the above embodiment of the present disclosure, the teacher network may be utilized to instruct the training of the student network, thereby improving the recognition precision of the student network. Untagged data is introduced during the training, and semantic information of the untagged data is fully utilized, which further improves the precision and generalization performance of the recognition model. Accordingly, the method may be well extended to other visual tasks.

In some alternative implementations of this embodiment, the selecting an input sample from the tagged sample set and the untagged sample set includes: selecting a tagged sample from the tagged sample set, and using the tagged sample as an input sample after data enhancement processing is performed on the tagged sample; and selecting an untagged sample from the untagged sample set, and using the untagged sample as an input sample after data enhancement processing is performed on the untagged sample. For the image in the selected sample, a random data augmentation (which may include an intensity transformation, random cropping, a random rotation, and the like) is performed, and an operation such as a resize operation and a normalization operation is then performed. Accordingly, a preprocessed image is generated to be used as an input sample. Therefore, not only the number of the samples can be expanded, but also the generalization capability of the model can be improved.

In some alternative implementations of this embodiment, the selecting an input sample from the tagged sample set and the untagged sample set includes: selecting, from the tagged sample set, a first number of tagged samples as an input sample; and selecting, from the untagged sample set, a second number of untagged samples as an input sample. Here, the second number is proportional to a difference between the maximum number of the iterations and a current number of iterations, and the sum of the first number and the second number is a fixed value. For example, the maximum number of the iterations for training is set to Emax, initial time is set to be within one batch, a ratio of a number of tagged samples to a number of samples in the batch is r₀, and an amount of training data within each batch is bs. The current number of the iterations is set to iter. A sampling ratio of the tagged samples is calculated as cr=r0*iter/Emax. Accordingly, cr*bs images are randomly selected from the tagged samples, and bs*(1−cr) images are randomly selected from the untagged samples, to constitute one batch of input samples. During training, the ratio of untagged data in the training set is gradually reduced, and even finally reduced to zero. In this way, the model can output more accurate information at a later stage of training, after learning the semantic information of the untagged data.

In some alternative implementations of this embodiment, calculating the total loss value based on the soft loss value, the first hard loss value and the second hard loss value includes: calculating the soft loss value based on the first predicted tag set and the second predicted tag set; calculating the first hard loss value based on the first predicted tag set and a corresponding real tag set; calculating the second hard loss value based on the second predicted tag set and a corresponding real tag set; determining a sum of the first hard loss value and the second hard loss value as a hard loss value; and calculating a weighted sum of the hard loss value and the soft loss value as the total loss value. Here, when a ratio of the soft loss value to the hard loss value is greater than a truncated hyperparameter, the soft loss value is truncated to be a product of the truncated hyperparameter and the hard loss value.

The input samples are sent to the knowledge distillation network. For all the samples, a loss value (soft loss value) between features of the student network and the teacher network is calculated, and denoted as Lwo. For tagged data, a CTC loss (first hard loss value) between the predicted tag of the student network and the real tag and a CTC loss (second hard loss value) between the predicted tag of the teacher network and the real tag are calculated simultaneously, and respectively denoted as Lsgt and Ltgt.

The total loss value Lall=a*(Lsgt+Ltgt)+b*Norm(Lwo) is calculated. Here, a,b are weight coefficients, Norm(Lwo) represents a truncation for the value of Lwo. A truncation rule refers to Lwo=min(th*(Lsgt+Ltgt),Lwo). Here, th refers to a truncated hyperparameter.

During the training, a loss function of the untagged data is truncated to ensure the proportion of a loss function calculated by using the real tag, thereby accelerating the training speed and improving the performance of the model.

In some alternative implementations of this embodiment, the structure of the student network and the structure of the teacher network are completely identical, and are randomly initialized. In this way, it is possible to avoid the problem that the student network has poor performance due to the simple structure.

In some alternative implementations of this embodiment, the selecting an image recognition model from the student network and the teacher network includes: acquiring a verification data set; verifying respectively performance of the student network and performance of the teacher network based on the verification data set; and determining a network having best performance in the student network and the teacher network as the image recognition model. The verification data set does not coincide with the tagged sample set and the untagged sample set. Each piece of verification data in the verification data set includes a verification image and a real value. A verification process refers to that the verification data set is respectively inputted into the student network and the teacher network to respectively obtain a prediction result. The prediction result is compared with the real value, to calculate performance indexes such as an accuracy rate and a recall rate. Therefore, the network having the best performance is determined as the image recognition model. Accordingly, the selection does not refer to the traditional method in which only the student network is used as the final model without taking the network performance into consideration. According to the implementations of the present disclosure, the performance of the trained image recognition model is improved, and thus, the accuracy of the image recognition can be improved.

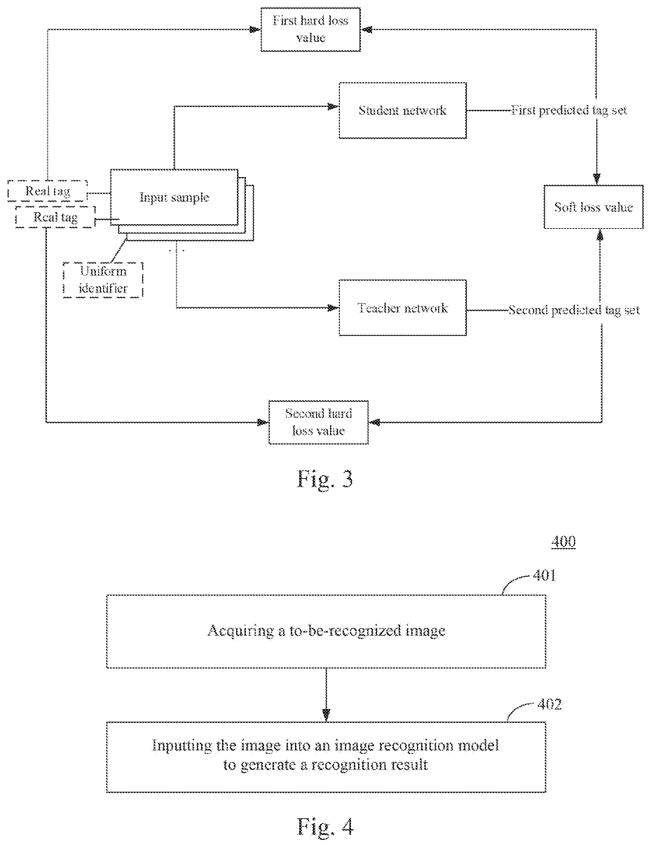

Further referring to FIG. 3, FIG. 3 is a schematic diagram of an application scenario of the method for training an image recognition model according to this embodiment. In the application scenario of FIG. 3, a model training application may be installed on a terminal used by a user. After the user opens the application and uploads a sample set (e.g., a signboard image is annotated with “NN Beef Noodle”) or a storage path of the sample set, a server providing backend support for the application may run the method for training an image recognition model, including the following steps:

1. A knowledge distillation network is constructed. The knowledge distillation network includes a student network and a teacher network, and the structure of the student network and the structure of the teacher network are completely identical, and are randomly initialized.

2. A training sample is prepared. For a tagged sample, the tag of the sample is a real tag. For an untagged sample, the tag of the sample is uniformly denoted as “###.”

3. A maximum number of iterations for training is set to Emax, initial time is set to be within one batch, a ratio of tagged data to a number of samples in the batch is r₀, and an amount of training data within each batch is bs.

4. A current number of iterations is set to iter. A sampling ratio of tagged samples is calculated as cr=r0*iter/Emax. Accordingly, cr*bs images are randomly selected from the tagged samples, and bs*(1−cr) images are randomly selected from untagged samples, to constitute one batch of data.

5. For the selected images, a random data augmentation (which includes an intensity transformation, random cropping, a random rotation, and the like) is performed, and an operation such as a resize operation and a normalization operation is then performed. Accordingly, preprocessed images are generated to be used as input samples.

6. The input samples are inputted into the knowledge distillation network. For all the samples, a loss function of features of the student network and the teacher network is calculated, and denoted as Lwo. For the tagged sample, a CTC loss between a prediction result of the student network and the real tag and a CTC loss between a prediction result of the teacher network and the real tag are calculated simultaneously, and respectively denoted as Lsgt and Ltgt.

7. A total loss function Lall=a*(Lsgt+Ltgt)+b*Norm(Lwo) is calculated. Here, a,b are weight coefficients, Norm(Lwo) represents a truncation for the value of Lwo. A truncation rule refers to Lwo=min(th*(Lsgt+Ltgt),Lwo). Here, th refers to a truncated hyperparameter.

8. A gradient is back propagated, and a parameter of the student network and a parameter of the teacher network are updated at the same time. The number of the iterations iter is increased by 1, and step 4 is repeated until a model reaches the maximum number of the iterations Emax.

9. The model is saved, the training process is terminated, and a higher-precision network in the student network and the teacher network is taken as the final required model.

Referring to FIG. 4, FIG. 4 illustrates a flow 400 of an embodiment of a method for recognizing an image provided in the present disclosure. The method for recognizing an image may include the following steps:

Step 401, acquiring a to-be-recognized image.

In this embodiment, an executing body (e.g., the server 105 shown in FIG. 1) of the method for recognizing an image may acquire the to-be-recognized image by various means. As an example, the executing body may acquire, from a database server (e.g., the database server 104 shown in FIG. 1), an image stored in the database server, by means of a wired connection or by means of a wireless connection. As another example, the executing body may receive the an image collected by a terminal (e.g., the terminals 101 and 102 shown in FIG. 1) or an other device.

In this embodiment, the image may also be a color image and/or a grayscale image. Moreover, the format of the image is not limited in the present disclosure.

Step 402, inputting the image into an image recognition model to generate a recognition result.

In this embodiment, the executing body may input the image acquired in step 401 into the image recognition model, thereby generating a recognition result of a detection object. The recognition result may be information used to describe a text in an image. For example, the recognition result may include whether the text is detected in the image, the content of the text when the text is detected, and the like.

In this embodiment, the image recognition model may be generated by using the method described in the above embodiment of FIG. 2. For the specific generation process, reference may be made to the related description in the embodiment of FIG. 2, which will not be repeatedly described here.

It should be noted that the method for recognizing an image in this embodiment may be used to test the image recognition model generated in the above embodiment. Then, the image recognition model may be continuously optimized according to the test result. The method may alternatively be an actual application method of the image recognition model generated in the above embodiment. Using the image recognition model generated in the above embodiment to perform the image recognition is helpful in improving the performance in the image recognition. If many images containing a text are found, the recognized text content is accurate.

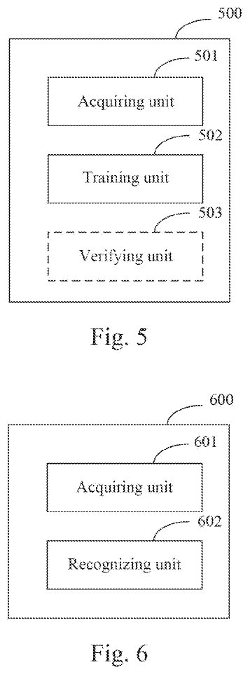

Further referring to FIG. 5, as an implementation of the method shown in the above drawings, the present disclosure provides an embodiment of an apparatus for training an image recognition model. The embodiment of the apparatus corresponds to the embodiment of the method shown in FIG. 2, and the apparatus may be applied in various electronic devices.

As shown in FIG. 5, the apparatus 500 for training an image recognition model in this embodiment includes: an acquiring unit 501 and a training unit 502. Here, the acquiring unit 501 is configured to acquire a tagged sample set, an untagged sample set and a knowledge distillation network. Here, a sample in the tagged sample set includes a sample image and a real tag, and a sample in the untagged sample set includes a sample image and a uniform identifier. The training unit 502 is configured to perform following training steps: selecting an input sample from the tagged sample set and the untagged sample set, and accumulating a number of iterations; inputting respectively the input sample into a student network and a teacher network of the knowledge distillation network to train the student network and the teacher network; and selecting an image recognition model from the student network and the teacher network, if a training completion condition is satisfied.

In some alternative implementations of this embodiment, the training unit 502 is further configured to: adjust, if the training completion condition is not satisfied, a relevant parameter in the student network and the teacher network, to continue to perform the training steps.

In some alternative implementations of this embodiment, the training completion condition comprises: the number of the iterations reaching a maximum number of iterations or a total loss value being less than a predetermined threshold.

In some alternative implementations of this embodiment, the training unit 502 is further configured to: input respectively the input sample into the student network and the teacher network of the knowledge distillation network to obtain a first predicted tag set and a second predicted tag set; and calculate the total loss value based on the first predicted tag set, the second predicted tag set and a real tag set.

In some alternative implementations of this embodiment, the training unit 502 is further configured to: calculate a soft loss value based on the first predicted tag set and the second predicted tag set; calculate a first hard loss value based on the first predicted tag set and a corresponding real tag set; calculate a second hard loss value based on the second predicted tag set and a corresponding real tag set; determine a sum of the first hard loss value and the second hard loss value as a hard loss value; and calculate a weighted sum of the hard loss value and the soft loss value as the total loss value. Here, when a ratio of the soft loss value to the hard loss value is greater than a truncated hyperparameter, the soft loss value is truncated to be a product of the truncated hyperparameter and the hard loss value. In some alternative implementations of this embodiment, the training unit 502 is further configured to: select a tagged sample from the tagged sample set, and use the tagged sample as an input sample after data enhancement processing is performed on the tagged sample; and select an untagged sample from the untagged sample set, and use the untagged sample as an input sample after data enhancement processing is performed on the untagged sample.

In some alternative implementations of this embodiment, the training unit 502 is further configured to: select, from the tagged sample set, a first number of tagged samples as an input sample; and select, from the untagged sample set, a second number of untagged samples as an input sample. Here, the second number is proportional to a difference between the maximum number of the iterations and a current number of iterations, and a sum of the first number and the second number is a fixed value.

In some alternative implementations of this embodiment, a structure of the student network and a structure of the teacher network are completely identical, and are randomly initialized.

In some alternative implementations of this embodiment, the apparatus 500 further includes a verifying unit 503. The verifying unit 503 is configured to: acquire a verification data set; verify respectively performance of the student network and performance of the teacher network based on the verification data set; and determine a network having best performance in the student network and the teacher network as the image recognition model.

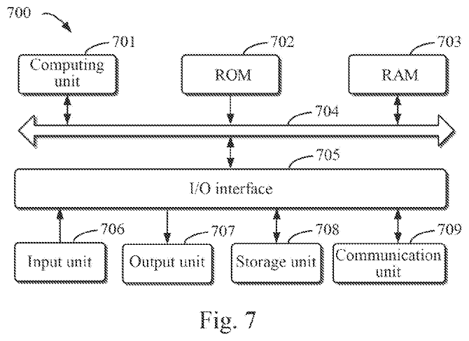

Further referring to FIG. 6, as an implementation of the method shown in the above drawings, the present disclosure provides an embodiment of an apparatus for recognizing an image. The embodiment of the apparatus corresponds to the embodiment of the method shown in FIG. 4, and the apparatus may be applied in various electronic devices.

As shown in FIG. 6, the apparatus 600 for recognizing an image in this embodiment includes: an acquiring unit 601 and a recognizing unit 602. Here, the acquiring unit 601 is configured to acquire a to-be-recognized image. The recognizing unit 602 is configured to input the image into an image recognition model generated by the apparatus 500, to generate a recognition result.

According to an embodiment of the present disclosure, the present disclosure further provides an electronic device, a readable storage medium, and a computer program product.

An electronic device includes at least one processor; and a storage device, communicated with the at least one processor. Here, the storage device stores an instruction executable by the at least one processor, and the instruction is executed by the at least one processor, to enable the at least one processor to perform the method in the flow 200 or 400.

A non-transitory computer readable storage medium stores a computer instruction. Here, the computer instruction is used to cause a computer to perform the method in the flow 200 or 400.

A computer program product includes a computer program. The computer program, when executed by a processor, implements the method in the flow 200 or 400.

FIG. 7 is a schematic block diagram of an exemplary electronic device 700 that may be used to implement the embodiments of the present disclosure. The electronic device is intended to represent various forms of digital computers such as a laptop computer, a desktop computer, a workstation, a personal digital assistant, a server, a blade server, a mainframe computer, and other appropriate computers. The electronic device may also represent various forms of mobile apparatuses such as personal digital processing, a cellular telephone, a smart phone, a wearable device and other similar computing apparatuses. The parts shown herein, their connections and relationships, and their functions are only as examples, and not intended to limit implementations of the present disclosure as described and/or claimed herein.

As shown in FIG. 7, the device 700 includes a computation unit 701, which may execute various appropriate actions and processes in accordance with a computer program stored in a read-only memory (ROM) 702 or a computer program loaded into a random access memory (RAM) 703 from a storage unit 708. The RAM 703 also stores various programs and data required by operations of the device 700. The computation unit 701, the ROM 702 and the RAM 703 are connected to each other through a bus 704. An input/output (I/O) interface 705 is also connected to the bus 704.

The following components in the device 700 are connected to the I/O interface 705: an input unit 706, for example, a keyboard and a mouse; an output unit 707, for example, various types of displays and a speaker; a storage device 708, for example, a magnetic disk and an optical disk; and a communication unit 709, for example, a network card, a modem, a wireless communication transceiver. The communication unit 709 allows the device 700 to exchange information/data with an other device through a computer network such as the Internet and/or various telecommunication networks.

The computation unit 701 may be various general-purpose and/or special-purpose processing assemblies having processing and computing capabilities. Some examples of the computation unit 701 include, but not limited to, a central processing unit (CPU), a graphics processing unit (GPU), various dedicated artificial intelligence (AI) computing chips, various processors that run a machine learning model algorithm, a digital signal processor (DSP), any appropriate processor, controller and microcontroller, etc. The computation unit 701 performs the various methods and processes described above, for example, the method for training an image recognition model. For example, in some embodiments, the method for training an image recognition model may be implemented as a computer software program, which is tangibly included in a machine readable medium, for example, the storage device 708. In some embodiments, part or all of the computer program may be loaded into and/or installed on the device 700 via the ROM 702 and/or the communication unit 709. When the computer program is loaded into the RAM 703 and executed by the computation unit 701, one or more steps of the above method for training an image recognition model may be performed. Alternatively, in other embodiments, the computation unit 701 may be configured to perform the method for training an image recognition model through any other appropriate approach (e.g., by means of firmware).

The various implementations of the systems and technologies described herein may be implemented in a digital electronic circuit system, an integrated circuit system, a field programmable gate array (FPGA), an application specific integrated circuit (ASIC), an application specific standard product (ASSP), a system-on-chip (SOC), a complex programmable logic device (CPLD), computer hardware, firmware, software and/or combinations thereof. The various implementations may include: being implemented in one or more computer programs, where the one or more computer programs may be executed and/or interpreted on a programmable system including at least one programmable processor, and the programmable processor may be a particular-purpose or general-purpose programmable processor, which may receive data and instructions from a storage system, at least one input device and at least one output device, and send the data and instructions to the storage system, the at least one input device and the at least one output device.

Program codes used to implement the method of embodiments of the present disclosure may be written in any combination of one or more programming languages. These program codes may be provided to a processor or controller of a general-purpose computer, particular-purpose computer or other programmable data processing apparatus, so that the program codes, when executed by the processor or the controller, cause the functions or operations specified in the flowcharts and/or block diagrams to be implemented. These program codes may be executed entirely on a machine, partly on the machine, partly on the machine as a stand-alone software package and partly on a remote machine, or entirely on the remote machine or a server.

In the context of the present disclosure, the machine-readable medium may be a tangible medium that may include or store a program for use by or in connection with an instruction execution system, apparatus or device. The machine-readable medium may be a machine-readable signal medium or a machine-readable storage medium. The machine-readable medium may include, but is not limited to, an electronic, magnetic, optical, electromagnetic, infrared, or semiconductor system, apparatus or device, or any appropriate combination thereof. A more particular example of the machine-readable storage medium may include an electronic connection based on one or more lines, a portable computer disk, a hard disk, a random-access memory (RAM), a read-only memory (ROM), an erasable programmable read-only memory (EPROM or flash memory), an optical fiber, a portable compact disk read-only memory (CD-ROM), an optical storage device, a magnetic storage device, or any appropriate combination thereof.

To provide interaction with a user, the systems and technologies described herein may be implemented on a computer having: a display device (such as a CRT (cathode ray tube) or LCD (liquid crystal display) monitor) for displaying information to the user; and a keyboard and a pointing device (such as a mouse or a trackball) through which the user may provide input to the computer. Other types of devices may also be used to provide interaction with the user. For example, the feedback provided to the user may be any form of sensory feedback (such as visual feedback, auditory feedback or tactile feedback); and input from the user may be received in any form, including acoustic input, speech input or tactile input.

The systems and technologies described herein may be implemented in: a computing system including a background component (such as a data server), or a computing system including a middleware component (such as an application server), or a computing system including a front-end component (such as a user computer having a graphical user interface or a web browser through which the user may interact with the implementations of the systems and technologies described herein), or a computing system including any combination of such background component, middleware component or front-end component. The components of the systems may be interconnected by any form or medium of digital data communication (such as a communication network). Examples of the communication network include a local area network (LAN), a wide area network (WAN), and the Internet.

A computer system may include a client and a server. The client and the server are generally remote from each other, and generally interact with each other through the communication network. A relationship between the client and the server is generated by computer programs running on a corresponding computer and having a client-server relationship with each other. The server may be a distributed system server, or a server combined with a blockchain. The server may also be a cloud server, or an intelligent cloud computing server or an intelligent cloud client with artificial intelligence technology.

It should be appreciated that the steps of reordering, adding or deleting may be executed using the various forms shown above. For example, the steps described in embodiments of the present disclosure may be executed in parallel or sequentially or in a different order, so long as the expected results of the technical schemas provided in embodiments of the present disclosure may be realized, and no limitation is imposed herein.

The above particular implementations are not intended to limit the scope of the present disclosure. It should be appreciated by those skilled in the art that various modifications, combinations, sub-combinations, and substitutions may be made depending on design requirements and other factors. Any modification, equivalent and modification that fall within the spirit and principles of the present disclosure are intended to be included within the scope of the present disclosure.

What is claimed is:

1. A method for training an image recognition model, comprising:
acquiring a tagged sample set, an untagged sample set and a knowledge distillation network, wherein a sample in the tagged sample set comprises a sample image and a real tag, and a sample in the untagged sample set comprises a sample image and a uniform identifier; and
performing following training steps: selecting an input sample from the tagged sample set and the untagged sample set, and accumulating a number of iterations; inputting respectively the input sample into a student network and a teacher network of the knowledge distillation network to train the student network and the teacher network; and selecting an image recognition model from the student network and the teacher network, if a training completion condition is satisfied.

2. The method according to claim 1, further comprising:
adjusting, if the training completion condition is not satisfied, a relevant parameter in the student network and the teacher network, to continue to perform the training steps.

3. The method according to claim 1, wherein the training completion condition comprises: the number of the iterations reaching a maximum number of iterations or a total loss value being less than a predetermined threshold.

4. The method according to claim 1, wherein the inputting respectively the input sample into a student network and a teacher network of the knowledge distillation network to train the student network and the teacher network comprises:
inputting respectively the input sample into the student network and the teacher network of the knowledge distillation network to obtain a first predicted tag set and a second predicted tag set; and
calculating a total loss value based on the first predicted tag set, the second predicted tag set and a real tag set.

5. The method according to claim 4, wherein the calculating the total loss value based on the first predicted tag set, the second predicted tag set and a real tag set comprises:
calculating a soft loss value based on the first predicted tag set and the second predicted tag set;
calculating a first hard loss value based on the first predicted tag set and a corresponding real tag set;
calculating a second hard loss value based on the second predicted tag set and a corresponding real tag set;
determining a sum of the first hard loss value and the second hard loss value as a hard loss value; and
calculating a weighted sum of the hard loss value and the soft loss value as the total loss value, wherein, when a ratio of the soft loss value to the hard loss value is greater than a truncated hyperparameter, the soft loss value is truncated to be a product of the truncated hyperparameter and the hard loss value.

6. The method according to claim 1, wherein the selecting an input sample from the tagged sample set and the untagged sample set comprises:
selecting a tagged sample from the tagged sample set, and using the tagged sample as an input sample after data enhancement processing is performed on the tagged sample; and
selecting an untagged sample from the untagged sample set, and using the untagged sample as an input sample after data enhancement processing is performed on the untagged sample.

7. The method according to claim 1, wherein the selecting an input sample from the tagged sample set and the untagged sample set comprises:
selecting, from the tagged sample set, a first number of tagged samples as an input sample; and
selecting, from the untagged sample set, a second number of untagged samples as an input sample,
wherein the second number is proportional to a difference between the maximum number of the iterations and a current number of iterations, and a sum of the first number and the second number is a fixed value.

8. The method according to claim 1, wherein a structure of the student network and a structure of the teacher network are completely identical, and are randomly initialized.

9. The method according to claim 1, wherein the selecting an image recognition model from the student network and the teacher network comprises:
acquiring a verification data set;
verifying respectively performance of the student network and performance of the teacher network based on the verification data set; and
determining a network having best performance in the student network and the teacher network as the image recognition model.

10. A method for recognizing an image, comprising:
acquiring a to-be-recognized image; and
inputting the image into an image recognition model to generate a recognition result, wherein the image recognition model is generated by operations for training an image recognition model, and the operations comprise:
acquiring a tagged sample set, an untagged sample set and a knowledge distillation network, wherein a sample in the tagged sample set comprises a sample image and a real tag, and a sample in the untagged sample set comprises a sample image and a uniform identifier; and
performing following training steps: selecting an input sample from the tagged sample set and the untagged sample set, and accumulating a number of iterations; inputting respectively the input sample into a student network and a teacher network of the knowledge distillation network to train the student network and the teacher network; and selecting an image recognition model from the student network and the teacher network, if a training completion condition is satisfied.

11. An electronic device, comprising:
at least one processor; and
a storage device, communicated with the at least one processor,
wherein the storage device stores an instruction executable by the at least one processor, and the instruction is executed by the at least one processor, to enable the at least one processor to perform first operations for training an image recognition model or second operations for recognizing an image;
the first operations comprise:
acquiring a tagged sample set, an untagged sample set and a knowledge distillation network, wherein a sample in the tagged sample set comprises a sample image and a real tag, and a sample in the untagged sample set comprises a sample image and a uniform identifier; and
performing following training steps: selecting an input sample from the tagged sample set and the untagged sample set, and accumulating a number of iterations; inputting respectively the input sample into a student network and a teacher network of the knowledge distillation network to train the student network and the teacher network; and selecting an image recognition model from the student network and the teacher network, if a training completion condition is satisfied; and
the second operations comprise:
acquiring a to-be-recognized image; and
inputting the image into an image recognition model to generate a recognition result, wherein the image recognition model is generated by the first operations.

12. The device according to claim 11, the first operations further comprising:
adjusting, if the training completion condition is not satisfied, a relevant parameter in the student network and the teacher network, to continue to perform the training steps.

13. The device according to claim 11, wherein the training completion condition comprises: the number of the iterations reaching a maximum number of iterations or a total loss value being less than a predetermined threshold.

14. The device according to claim 11, wherein the inputting respectively the input sample into a student network and a teacher network of the knowledge distillation network to train the student network and the teacher network comprises:
inputting respectively the input sample into the student network and the teacher network of the knowledge distillation network to obtain a first predicted tag set and a second predicted tag set; and
calculating a total loss value based on the first predicted tag set, the second predicted tag set and a real tag set.

15. The device according to claim 14, wherein the calculating the total loss value based on the first predicted tag set, the second predicted tag set and a real tag set comprises:
calculating a soft loss value based on the first predicted tag set and the second predicted tag set;
calculating a first hard loss value based on the first predicted tag set and a corresponding real tag set;
calculating a second hard loss value based on the second predicted tag set and a corresponding real tag set;
determining a sum of the first hard loss value and the second hard loss value as a hard loss value; and
calculating a weighted sum of the hard loss value and the soft loss value as the total loss value, wherein, when a ratio of the soft loss value to the hard loss value is greater than a truncated hyperparameter, the soft loss value is truncated to be a product of the truncated hyperparameter and the hard loss value.

16. The device according to claim 11, wherein the selecting an input sample from the tagged sample set and the untagged sample set comprises:
selecting a tagged sample from the tagged sample set, and using the tagged sample as an input sample after data enhancement processing is performed on the tagged sample; and
selecting an untagged sample from the untagged sample set, and using the untagged sample as an input sample after data enhancement processing is performed on the untagged sample.

17. The device according to claim 11, wherein the selecting an input sample from the tagged sample set and the untagged sample set comprises:
selecting, from the tagged sample set, a first number of tagged samples as an input sample; and
selecting, from the untagged sample set, a second number of untagged samples as an input sample, wherein the second number is proportional to a difference between the maximum number of the iterations and a current number of iterations, and a sum of the first number and the second number is a fixed value.

18. The device according to claim 11, wherein a structure of the student network and a structure of the teacher network are completely identical, and are randomly initialized.

19. The device according to claim 11, wherein the selecting an image recognition model from the student network and the teacher network comprises:
acquiring a verification data set;
verifying respectively performance of the student network and performance of the teacher network based on the verification data set; and
determining a network having best performance in the student network and the teacher network as the image recognition model.
